(19) United States
(12) Patent Application Publication
(10) Pub. No.: US 2024/0389797 A1
(43) Pub. Date: Nov. 28, 2024

(54) COFFEE GRINDER

(71) Applicant: DANPING LIU, Shenzhen City (CN)

(72) Inventor: DANPING LIU, Shenzhen City (CN)

(21) Appl. No.: 18/525,830

(22) Filed: Nov. 30, 2023

(30) Foreign Application Priority Data
May 22, 2023 (CN) 202321244897.3

(51) Int. Cl. A47J 42/50; A47J 42/06; A47J 42/08; A47J 42/10; A47J 42/40; A47J 42/46

(52) U.S. Cl. CPC A47J 42/50; A47J 42/06; A47J 42/08; A47J 42/10; A47J 42/40; A47J 42/46

(57) ABSTRACT

The present invention provides a coffee grinder, which comprises a storage chamber for storing coffee beans; a driving assembly having an output shaft; a grinding cartridge; a grinding assembly comprising a grinding wheel rotatably fitted in a grinding base so as to grind coffee beans therebetween; a control circuit board; one or more battery electrically connected to the control circuit board; and a powder receptacle; wherein, the grinding cartridge is longitudinally connected and communicated with the storage chamber at a top end and the powder receptacle at a rear end; the grinding assembly is installed in the grinding cartridge; and the driving assembly is longitudinally disposed in the storage chamber with the output shaft coupled to the grinding assembly to drive the grinding wheel to rotate.

### CROSS REFERENCE TO RELATED APPLICATIONS

The present invention is a 35 U.S.C. § 119 benefit of earlier filing date; right of priority of Chinese Application No. 202321244897.3, filed on May 22, 2023, the disclosure of which is incorporated by reference herein.

### BACKGROUND OF THE INVENTION

### Field of the Invention

The present invention relates to the field of coffee equipment, and more particularly, to a coffee grinder.

### Description of Related Art

Existing Portable coffee grinders usually have a drive module and circuit control module placed in an upper main chamber. The main chamber is larger and heavier, a bean container is set in the middle, and a grinding module and a powder receptacle is connected below. The bean container needs to leave a grinding drive space, resulting in very little space to accommodate coffee beans. In addition, when feeding coffee bean, the main chamber and bean container need to be removed by manual rotation, and installed together after feeding, since the grinding connection therebetween needs to be carefully disassembled and then installed carefully, and the main chamber is larger and heavier, it is more complicated and troublesome to operate.

Therefore, it is necessary to provide a coffee grinder with a large coffee bean storage space and simple and convenient operation.

### BRIEF SUMMARY OF THE INVENTION

An object of the present invention is to provide a coffee grinder with a large coffee bean storage space and simple and convenient operation.

The present invention provides a coffee grinder, comprising: a storage chamber for storing coffee beans; a driving assembly having an output shaft; a grinding cartridge; a grinding assembly comprising a grinding wheel rotatably fitted in a grinding base so as to grind coffee beans therebetween; a control circuit board; one or more battery electrically connected to the control circuit board; and a powder receptacle; wherein, the grinding cartridge is longitudinally connected and communicated with the storage chamber at a top end and the powder receptacle at a rear end; the grinding assembly is installed in the grinding cartridge; and the driving assembly is longitudinally disposed in the storage chamber with the output shaft coupled to the grinding assembly to drive the grinding wheel to rotate.

The storage chamber has a cylindrical shell, a storage cover is provided to removably close an open of the cylindrical shell, which can be removed or opened for adding coffee beans to the storage chamber from the open.

The driving assembly comprising a motor longitudinally arranged in the storage chamber, the motor has the output shaft is fixedly connected to the grinding wheel.

The grinding cartridge has an annular base at a top end thereof, the cylindrical shell of the storage chamber has a rear open end connected to the top end of the grinding cartridge; the motor is installed on the annular base and longitudinally extends along a central axis of the storage chamber; and the output shaft passes through a central through hole of the annular base and extends along a central axis of the grinding cartridge.

The driving assembly comprise a housing arranged outside the motor to fixing the motor, the housing is fixed to the annular base of the grinding cartridge; the driving assembly further comprise a gear assembly connected to the motor so that the output shaft drives the grinding wheel to rotate at a desired speed.

In some embodiments, the cylindrical shell and/or the storage cover of the storage chamber are transparent.

In some embodiments, the grinding cartridge comprises a cylindrical shell with an annular base provided at a top end and an annular cover at a rear open end of the cylindrical shell, respectively; central through holes of the annular base, annular cover, grinding wheel, and the grinding base are aligned along a central axis of the grinding cartridge, whereby the output shaft passes through said central through holes, and coffee powder can be dropped to the powder receptacle through said central through holes.

The control circuit board is disposed in the grinding cartridge; and the one or more battery is disposed in the grinding cartridge.

In some embodiments, the grinding cartridge defines a first chamber and the second chamber therein; the grinding assembly is disposed in the first chamber, and the control circuit board and the one or more battery are disposed in the second chamber.

Further, the first chamber is disposed in a center of the grinding cartridge, the second chamber is disposed around the first chamber; the one or more battery and the control circuit board are located in the second chamber and around a periphery of the grinding assembly; the second chamber is an annular space; and the first chamber and the second chamber are separated by an annular protruding wall set within the cylindrical shell of the grinding cartridge; the annular protruding wall defines the first chamber therein; the grinding base is fitted in the first chamber against the annular protruding wall.

In some embodiments, the coffee grinder as claimed in claim 1, wherein the grinding cartridge comprises an outer cylindrical shell, a first inner cylindrical shell, and a second inner cylindrical shell; a first chamber for accommodating the grinding assembly and a second chamber around the first chamber for accommodating the circuit board and the one or more battery are concentrically formed within the second inner cylindrical shell; the outer cylindrical shell is connected to the storage chamber at a top end, and is connected to the powder receptacle at a rear end thereof; each of the first and second inner cylindrical shells has an annular base at a top end thereof; the first inner cylindrical shell is fitted in the outer cylindrical shell; the driving assembly is fixed on the annular base of the first inner cylindrical shell; the second inner cylindrical is fitted in the first inner cylindrical; and the annular bases of the first and second inner cylindrical shells are fixed together.

In some embodiments, an annular cover is provided at a rear end of the second inner cylindrical shell; an end of the output shaft with external threads passes through a central hole of the annular cover and is locked by a thread nut; the first inner cylindrical shell, a second inner cylindrical shell and the outer cylindrical shell are fastened using screws and/or snap structures.

In some embodiments, an adjustable member is provided with a threaded hole therethrough, an end of the output shaft is provided with external threads; the threaded end of the output shaft is engaged in the threaded hole of the adjustable member, whereby the output shaft is fitted in the grinding wheel with a tightness adjustable.

In some embodiments, the grinding cartridge has an annular cover at a rear end and communicated with the powder receptacle; the adjustable member is placed in the central through hole and exposed in the powder receptacle; the adjustable member is a thread nut assembly.

The present invention has the following advantages:

The coffee grinder of the present invention has the driving assembly installed in the storage chamber, and its output end can be directly connected to the grinding assembly in the grinding cartridge. The driving assembly can be highly integrated and only takes up a small space, so the Other larger spaces can be fully utilized to place coffee beans, which can maximize space utilization, making the bean storage space of the grinding device of the present invention several times larger than that of common grinding devices of the same size. Moreover, when you need to place coffee beans, you only need to open the storage chamber to easily put the coffee beans in, without the need for a large and bulky body with a control component and a grinding assembly like common grinding devices. The chamber can be removed and reinstalled, making the bean loading operation of the coffee grinder of the present invention simpler and easier. The control device of this application can also make full use of the space around the grinding assembly to maximize space utilization.

### BRIEF DESCRIPTION OF THE DRAWINGS

FIG. 1 is a perspective view of a coffee grinder in accordance with an embodiment of the present invention;

FIG. 2 is another perspective view of the coffee grinder in accordance with the embodiment of the present invention;

FIG. 3 is an exploded view of the coffee grinder in accordance with the embodiment of the present invention; and

FIG. 4 is another exploded view of the coffee grinder in accordance with the embodiment of the present invention.

### DETAILED DESCRIPTION OF THE INVENTION

In order to make the subject, technical solutions, and advantages of the present invention clearer, the present invention will be described in further detail below with reference to the accompanying drawings and embodiments. The embodiments described herein are only used to explain the present invention, but not to limit the present invention.

It is to be understood that the embodiments below are used for example only and is not intended to be limiting. As used in the description or claims, the singular forms “a,” “an,” and “the” are intended to include the plural forms as well, unless the context clearly dictates otherwise. The terms “comprise”, “include”, “contain” and “have” are inclusive and thus indicate the presence of stated features, steps, operations, elements and/or components but do not exclude the presence or addition of one or various other features, steps, operations, elements, components, and/or combinations thereof.

Although the terms first, second, third, etc. may be used in the description or claims to describe various elements, components, regions, layers and/or sections, these elements, components, regions, layers and/or sections shall not be referred to as restricted by these terms. These terms are only used to distinguish one element, component, region, layer or section from another region, layer or section. Terms such as “first,” “second,” and other numerical terms when used in the description or claims do not imply a sequence or order unless clearly indicated by the context. Thus, a first element, component, region, layer or section discussed below could be termed a second element, component, region, layer or section without departing from the teachings of the example embodiments.

For convenience of description, spatially relative terms may be used herein to describe the relationship of one element or feature to another element or feature as shown in the figures. These relative terms, such as “inner”, “outer”, “inside”, “outside”, “below”, “under”, “above”, “on”, “top”, “rear”, etc. Such spatially relative terms are intended to cover different orientations of the device in use or operation in addition to the orientation depicted in the figures. For example, if the device in the figures is turned over, elements described as “below” or “under” other elements or features would then be oriented “above” or “on” the other elements or features. The device may be otherwise oriented (rotated 90 degrees or at other orientations) and the spatially relative terms used are interpreted accordingly.

The following embodiments illustrate the technical solutions.

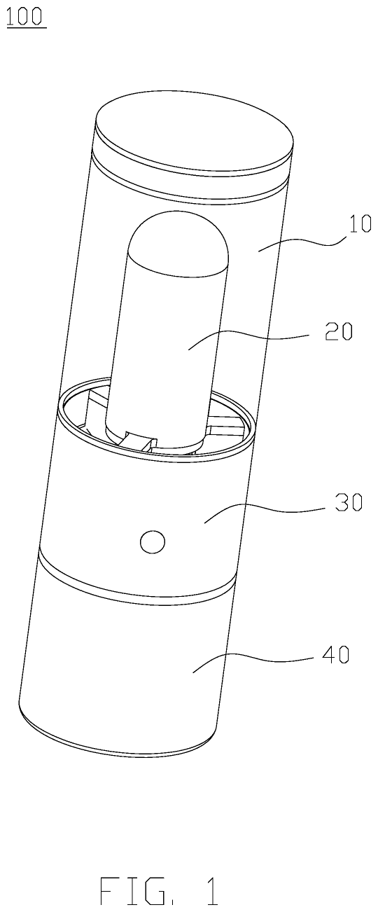

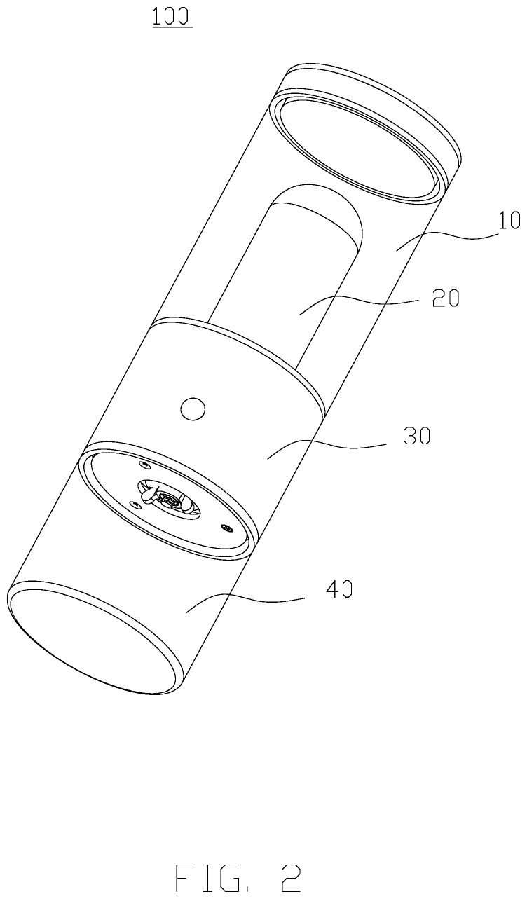

Referring to FIGS. 1-2, a coffee grinder 100 in accordance with an embodiment of the present invention, comprises a storage chamber 10, a driving assembly 20, a grinding cartridge 30, a grinding assembly 70, and a powder receptacle 400. The grinding cartridge 30 is connected and communicated with the storage chamber 10 at a top end and the powder receptacle 400 at a rear end. An output end of the driving assembly 20 is coupled to the grinding assembly 70. The grinding assembly 70 is disposed in the grinding cartridge 30, the driving assembly 20 is disposed in the storage chamber 10, and a bean storage space for placing coffee beans is left in the storage chamber 10.

The coffee grinder 100 of the present invention sets the driving assembly 20 in the storage chamber 10. The driving assembly 20 can be configured to take up only a small space, so that the left larger spaces in the storage chamber 10 can be fully utilized for storing coffee beans, which can maximize the use of space, and obtain the bean storage space several times larger than the existing coffee grinder of the same size. Moreover, when feeding coffee beans, only open the storage chamber 10 to easily put the coffee beans in. The coffee grinder 100 of the present invention is simpler and easier to feed coffee beans therein.

Specifically, the storage chamber 10 is defined by a cylindrical shell 1, and the bean storage space is formed between the cylindrical shell 1 and the driving assembly 20. A storage cover 11 is connected to a top open end of the cylindrical shell 1 to close the storage chamber 10, and can be removed or opened for adding coffee beans to the storage chamber 10.

The grinding cartridge 30 comprises an outer cylindrical shell 3, and a first inner cylindrical shell 31 and a second inner cylindrical shell 32 that are placed in the outer cylindrical shell 3 and are sleeved and installed with each other. The second inner cylindrical shell 32 can be sleeved and fixed in the first inner cylindrical shell 31. The outer cylindrical shell 3 is sleeved outside the first inner cylindrical shell 31 and connected to the cylindrical shell 1 of the storage chamber 10. As an example, the cylindrical shell 1 and the outer cylindrical shell 3 has same diameters, the open rear end of the cylindrical shell 1 can be tightly connected to a rear open end of the outer cylindrical shell 3 with buckle or snap structures. The first inner cylindrical shell 31 can be fitted in the outer cylindrical shell 3 and further fastened by buckle or snap structures and screws. The second inner cylindrical shell 321 can be fitted in the first inner cylindrical shell 31 and further fastened by buckle or snap structures and screws. The first inner cylindrical shell 31 and the second cylindrical shell 32 have an annular base 311, 321 with a through central hole respectively for the output shaft 25 passing through. The driving assembly 20 is fixed on the annular base 311 of the first inner cylindrical shell 31. Specifically, the motor 21 is fixed to the housing 22, and the housing 22 is fixed to the annular base 311. Protruding legs may be formed on the wall of the housing 22. The annular base 311 may forms according connecting legs, the leges are fixed together by screws or protrusions/holes. The annular base 321 of the second cylindrical shall 32 rests on the annular base 311 of the first cylindrical shell 31, there are protruding posts are set on the annular base 311 which pass through holes in the annular base 321 for positioning, and screws are provided to further fasten the annular bases 311, 321 together. An annular cover 35 is provided to cover a rear open end of the assembled first inner cylindrical shell 31, second cylindrical shell 32 and the outer cylindrical shell 3, the output shaft 35 passes through a central through hole in the cover 35. Protrusions/holes can be set in/on the walls of the shells 3, 31 and 32 for positioning.

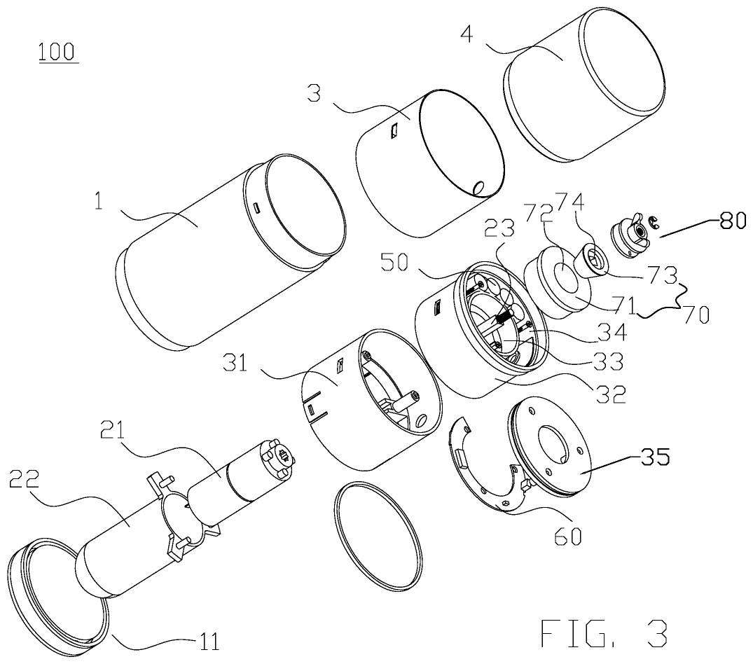

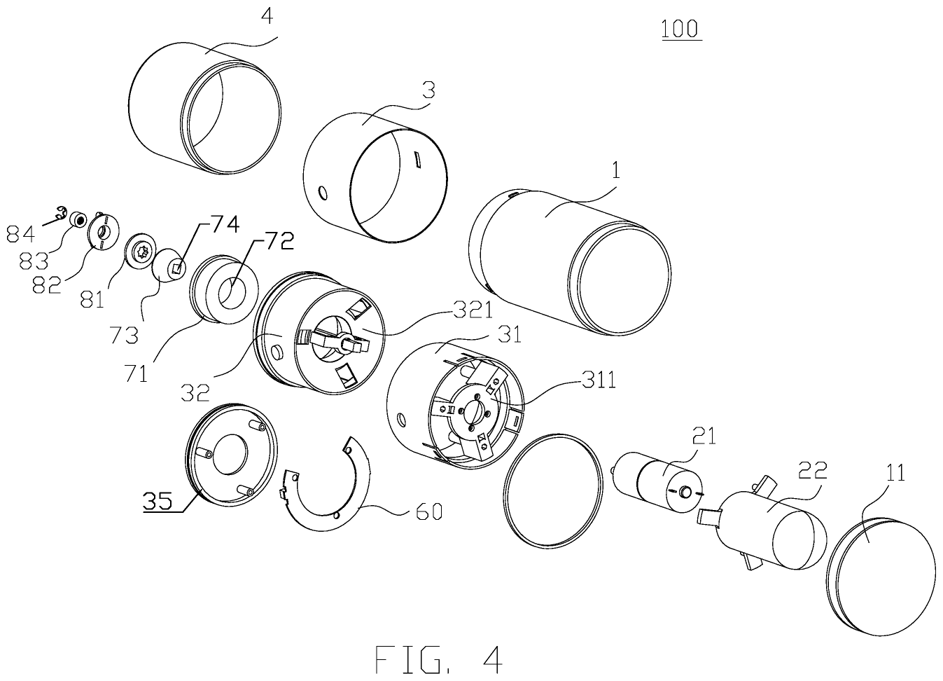

Referring to FIGS. 3 and 4, the coffee grinder 100 further comprises a control circuit board 60 and one or more battery 50 which are disposed in the grinding cartridge 30. The control circuit board 60 and the one or more battery 50 are arranged around a periphery of the grinding assembly 70. The grinding cartridge 30 defines a first chamber 33 and a second chamber 34 therein. The first chamber 33 and the second chamber 34 are formed in the second inner cylindrical shell 32. An annular wall extending from the annular base 321 and parallel to the to second inner cylindrical shell 32 defines the first chamber 33 in the annular base 321, and defines the second chamber 34 between the shell 32 and the annular wall. The grinding assembly 70 is disposed in the first chamber 33, and the control circuit board 60 and the one or more battery 50 are disposed in the second chamber 34. The grinding assembly 70 in the first chamber 33 is connected to the driving assembly 20. As shown in FIGS. 3 and 4, the first chamber 33 is disposed in a center of the grinding cartridge 30, and the second chamber 34 is disposed around the first chamber 33. That is, the grinding assembly 70 is disposed in the first chamber 33 in the center, and the control circuit board 60 and the one or more battery 50 is disposed in the second chamber 34 around the first chamber 33. Specifically, the second chamber 34 is an annular space provided around the second chamber 34.

In this embodiment, the control circuit board 60 is electrically connected to the one or more battery 50. The one or more battery 50 and the control circuit board 60 are both disposed in the annular second chamber 34. One or more button such as a power button etc. is provided and electrically connected to the control circuit board 60.

The drive assembly 20 comprises a motor 21 arranged longitudinally in the storage chamber 10 and electrically connected to the control circuit board 60. The motor 21 has an output shaft 23 extending through the grinding cartridge 30 and coupled to the grinding assembly 70. The drive assembly 20 may further comprise an existing gear assembly connected to the motor 21 so that the output shaft 23 drive a grinding wheel 73 to rotate at a desired speed. The drive assembly 20 has a housing 22 adapted for the motor 21. The motor 21 and the gear assembly are placed in the housing 22. The housing 22 can be fixedly installed to the first inner cylindrical shell 31, specifically, the housing 22 can be fixed on a base 311 of the first inner cylindrical shell 31 through screws. The base 311 can be set at a top open end of the first inner cylindrical shell 31, and defines a central through hole therethrough. The output shaft 23 of the driving assembly 20 passes through the central through holes of the bases 311, 321 and extending in the first chamber 33 to be connected with the grinding assembly 70.

The grinding assembly 70 comprises a grinding base 71 and a grinding wheel 73. The grinding base 71 and the grinding wheel 73 define a central through hole 72, 74 respectively, the grinding wheel 73 is rotatably fitted in the central through hole 72 of the grinding base 71. The grinding wheel 73 rotate so as to grind the coffee bean between the grinding wheel 73 and the grinding base 71. The grinding base 71 and the grinding wheel 73 are assembled in the first chamber 33. The output shaft 23 of the driving assembly 20 passes the central through holes 72, 74 of the grinding base 71 and the grinding wheel 73, and is fixedly connected to the grinding wheel 73. The grinding base 71 is disposed in the first chamber 33 and against the annular wall within the second cylindrical shell 32. The output shaft 23 has a shape adapted for the central through hole 74 of the grinding wheel 73, for example, the output shaft 23 is a polygonal axis, and the central through hole 74 is a polygonal inner hole for the polygonal axis being fixedly fitted therethrough.

An adjustable member 80 is provided with a threaded hole therethrough, an end of the output shaft 23 is provided with external (or male) threads; the threaded end of the output shaft 23 is engaged in the threaded hole of the adjustable member 80, so that the output shaft 23 is fitted in the grinding wheel 73 with a tightness adjustable. The adjustable member 80 is placed in the central through hole of the annular cover 35 and exposed in the powder receptacle 400 for operating. For example, the adjustable member 80 is a thread nut assembly, which comprises a screw washer 81 with a polygonal inner hole, an adjustment ring 82, a cylindrical screw threaded column 83 with an internal thread hole therethrough, and a locking dome (metal dome) 84 in a shape of an open ring. Where the screw washer 81 is disposed at a rear end of the grinding wheel 73. The adjustment ring 83 has a central through hole and operating protrusions, and rests on the screw washer 81. The cylindrical screw threaded column 83 is tightly fitted in the central holes of the screw washer 81 and the adjustment ring 82. The locking dome 84 is fitted in the internal thread hole of the column 84, and locks the threaded end of the output shaft 23. The output shaft 23 passes through the through hole of the grinding wheel 73, the screw washer 81 and the cylindrical screw threaded column 84, and is locked in the internal thread hole. The user can hold the protrusion to rotate the adjustable member 80 for tightening or loosening the connection between output shaft 23 and the grinding wheel 73.

The output shaft 23 of the motor 21 passes through the central through holes of the first and second inner shell 31, 32, the grinding base 71 and the grinding wheel 73 in the grinding cartridge 30, and passes through the central through holes of the adjustable member 80 (specifically the screw washer 81 and the cylindrical screw threaded column 83), and the threaded end of the output shaft 23 is engaged in and locked by the thread nut assembly.

The powder receptacle 40 is removable or opened and connected to a rear end of the grinding cartridge 30, the coffee powder from the grinding assembly 70 can drop into the powder receptacle 40 through the central hole of the cover 35 of the grinding cartridge 30. The powder receptacle 41 includes a housing 41, which can be connected and installed with the outer cylindrical shell 3 of the grinding cartridge 30 through a snap or screw fit.

The cylindrical shell 1 can be made of transparent material, which makes it easier to observe the remaining coffee beans. The powder receptacle 40 may be made of transparent material too, so as to observe the amount of coffee powder.

In this embodiment, the driving assembly 20 is longitudinally placed in the center of the storage chamber 10, and the bean storage space comprises a space surrounding the driving assembly 20. When the driving assembly 20 is placed in the center of the storage chamber 10, it can connect and drive the grinding assembly 70 more directly, reducing some parts required for power transmission, making the structure more compact. The driving assembly 20 and the grinding assembly 70 take up less space and has higher space utilization. The storage cover 11 can directly cooperate with the cylindrical shell 1 in a buckle/snap or thread manner. When adding coffee beans, easily remove the storage cover 11. There is still the bean storage space between the storage cover 11 and the driving assembly 20. That is, the space surrounding and above the driving assembly 20 can be used as the bean storage space, and the space is fully utilized.

The coffee grinder of the present invention disposes the driving assembly 20 in the storage chamber 10, and its output shaft can be directly connected to the grinding assembly 70 in the grinding cartridge 30. The driving assembly 20 can be highly compacted and only takes up a small space, so the other larger spaces in the storage chamber 10 can be fully utilized to place coffee beans, which can maximize the use of space, and the bean storage space of the grinder of the present invention is several times larger than that of common grinders of the same size. Moreover, when feeding coffee beans, only need to open the storage cover 11 of storage chamber 10 to easily put the coffee beans in. There is no need to remove and reinstall a large and bulky main body with the control assembly and the grinding assembly like common grinders. The main chamber can be removed and reinstalled, the coffee grinder of the present invention can be added bean simpler and easier. The present invention uses the annular space surrounding the grinding assembly 70 to place the control circuit board 60 and batteries 50, which make full use of the remaining space around the grinding assembly, thereby maximize space utilization.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. A coffee grinder, comprising:
a storage chamber for storing coffee beans;
a driving assembly having an output shaft;
a grinding cartridge;
a grinding assembly comprising a grinding wheel rotatably fitted in a grinding base so as to grind coffee beans therebetween;
a control circuit board;
one or more battery electrically connected to the control circuit board; and
a powder receptacle;
wherein, the grinding cartridge is longitudinally connected and communicated with the storage chamber at a top end and the powder receptacle at a rear end; the grinding assembly is installed in the grinding cartridge; and the driving assembly is longitudinally disposed in the storage chamber with the output shaft coupled to the grinding assembly to drive the grinding wheel to rotate.

2. The coffee grinder as claimed in claim 1, wherein the storage chamber has a cylindrical shell, a storage cover is provided to removably close an open of the cylindrical shell, which can be removed or opened for adding coffee beans to the storage chamber from the open.

3. The coffee grinder as claimed in claim 1, wherein the driving assembly comprising a motor longitudinally arranged in the storage chamber, the motor has the output shaft is fixedly connected to the grinding wheel.

4. The coffee grinder as claimed in claim 3, wherein the grinding cartridge has an annular base at a top end thereof, the cylindrical shell of the storage chamber has a rear open end connected to the top end of the grinding cartridge; the motor is installed on the annular base and longitudinally extends along a central axis of the storage chamber; and the output shaft passes through a central through hole of the annular base and extends along a central axis of the grinding cartridge.

5. The coffee grinder as claimed in claim 4, wherein the driving assembly comprise a housing arranged outside the motor to fixing the motor, the housing is fixed to the annular base of the grinding cartridge;
the driving assembly further comprise a gear assembly connected to the motor so that the output shaft drives the grinding wheel to rotate at a desired speed.

6. The coffee grinder as claimed in claim 2, wherein the cylindrical shell and/or the storage cover of the storage chamber are transparent.

7. The coffee grinder as claimed in claim 1, wherein the grinding cartridge comprises a cylindrical shell with an annular base provided at a top end and an annular cover at a rear open end of the cylindrical shell, respectively; central through holes of the annular base, annular cover, grinding wheel, and the grinding base are aligned along a central axis of the grinding cartridge, whereby the output shaft passes through said central through holes, and coffee powder can be dropped to the powder receptacle through said central through holes.

8. The coffee grinder as claimed in claim 7, wherein the control circuit board is disposed in the grinding cartridge; and the one or more battery is disposed in the grinding cartridge.

9. The coffee grinder as claimed in claim 8, wherein the grinding cartridge defines a first chamber and the second chamber therein; the grinding assembly is disposed in the first chamber, and the control circuit board and the one or more battery are disposed in the second chamber.

10. The coffee grinder as claimed in claim 9, wherein the first chamber is disposed in a center of the grinding cartridge, the second chamber is disposed around the first chamber; the one or more battery and the control circuit board are located in the second chamber and around a periphery of the grinding assembly;
the second chamber is an annular space; and the first chamber and the second chamber are separated by an annular protruding wall set within the cylindrical shell of the grinding cartridge; the annular protruding wall defines the first chamber therein;
the grinding base is fitted in the first chamber against the annular protruding wall.

11. The coffee grinder as claimed in claim 1, wherein the grinding cartridge comprises an outer cylindrical shell, a first inner cylindrical shell, and a second inner cylindrical shell;
a first chamber for accommodating the grinding assembly and a second chamber around the first chamber for accommodating the circuit board and the one or more battery are concentrically formed within the second inner cylindrical shell;
the outer cylindrical shell is connected to the storage chamber at a top end, and is connected to the powder receptacle at a rear end thereof;
each of the first and second inner cylindrical shells has an annular base at a top end thereof;
the first inner cylindrical shell is fitted in the outer cylindrical shell; the driving assembly is fixed on the annular base of the first inner cylindrical shell;
the second inner cylindrical is fitted in the first inner cylindrical; and the annular bases of the first and second inner cylindrical shells are fixed together.

12. The coffee grinder as claimed in claim 11, wherein an annular cover is provided at a rear end of the second inner cylindrical shell;
an end of the output shaft with external threads passes through a central hole of the annular cover and is locked by a thread nut;
the first inner cylindrical shell, a second inner cylindrical shell and the outer cylindrical shell are fastened using screws and/or snap structures.

13. The coffee grinder as claimed in claim 1, wherein an adjustable member is provided with a threaded hole therethrough, an end of the output shaft is provided with external threads; the threaded end of the output shaft is engaged in the threaded hole of the adjustable member, whereby the output shaft is fitted in the grinding wheel with a tightness adjustable.

14. The coffee grinder as claimed in claim 13, wherein the grinding cartridge has an annular cover at a rear end and communicated with the powder receptacle; the adjustable member is placed in the central through hole and exposed in the powder receptacle; the adjustable member is a thread nut assembly.
